(19) United States
(12) Patent Application Publication
(10) Pub. No.: US 2007/0014197 A1
(43) Pub. Date: Jan. 18, 2007

(54) Read-out control for use with a domain expansion recording medium

(75) Inventor: Coen Adrianus Verschuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/570,541

(22) PCT Filed: Aug. 26, 2004
(86) PCT No.: PCT/IB04/51571

§ 371 Date: Mar. 3, 2006

(30) Foreign Application Priority Data
Sep. 10, 2003 (EP) 03103337.6

(51) Int. Cl. G11B 11/00

(52) U.S. Cl. 369/13.26

(57) ABSTRACT

The present invention relates to a reading method and apparatus for reading a magneto-optical recording medium comprising at least one storage layer and a read-out layer, wherein an expanded domain leading to a read-out pulse is generated in the read-out layer by copying of a mark region from the at least one storage layer to the read-out layer through heating by a radiation power and with the help of an external magnetic field. A parameter indicating the presence or strength of a local deviation in the read-out characteristic of the recording medium is determined during a reading operation, and the radiation power is then controlled on the basis of on the determined parameter. The proposed procedure can be used during a read-out operation based on a reflected power, read-out error, or phase error. Hence, a fast and efficient power control mechanism that can be independent of a copy window control mechanism is provided. Moreover, crosstalk between first and second storage layers can be prevented by keeping the read-out temperature close to the compensation temperature of the other storage layer which is not read.

The present invention relates to a method and apparatus for reading a recording medium, such as a single-layer or multi storage layer MAMMOS (Magnetic AMplifying Magneto-Optical System) disc. A single-layer MAMMOS disc comprises a single recording or storage layer and an expansion or read-out layer, whereas a multi layer MAMMOS disc comprises at least two recording or storage layers and one expansion or read-out layer.

In conventional magneto-optical storage systems, the minimum width of the recorded marks is determined by the diffraction limit, that is, by the Numerical Aperture (NA) of the focusing lens and the laser wavelength. A reduction of the width is generally based on shorter wavelength lasers and higher-NA focusing optics. During magneto-optical recording, the minimum bit length can be reduced to below the optical diffraction limit by using Laser Pulsed Magnetic Field Modulation (LP-MFM). In LP-MFM, the bit transitions are determined by the switching of the field and the temperature gradient induced by the switching of a radiation source, such as a laser.

In domain expansion techniques, like MAMMOS, a written mark with a size smaller than the diffraction limit is copied from a storage layer to a read-out layer upon laser heating and with the help of an external magnetic field during read out of the recording medium. Due to the low coercivity of this read-out layer, the copied mark will expand to fill the optical spot and can be detected with a saturated signal level that is independent of the mark size. Reversal of the external magnetic field collapses the expanded domain. On the other hand, a space in the storage layer will not be copied and no expansion will occur. Therefore, no signal will be detected in this case.

To read out the bits or domains in the storage layer, the thermal profile of the optical spot is used. When the temperature of the read-out layer is above a predetermined threshold value, the magnetic domains are copied from the storage layer to the magneto-statically coupled read-out layer. This is because the stray field H_{S} from the storage layer, which is proportional to the magnetization of this layer, increases as a function of the temperature. The magnetization M_{S} increases as a function of the temperature for a temperature region just above a compensation temperature T_{co} where the effective magnetization, and thus the stray field of the storage layer, is reduced to zero. This characteristic results from the use of a rare earth-transition metal (RE-TM) alloy which generates two counteracting magnetizations M_{RE} (rare earth component) and M_{TM} (transition metal component) with opposite directions.

The application of an external magnetic field causes, the copied domain in the read-out layer to expand so as to give a saturated detection signal independent of the size of the original domain. The copying process is non-linear. When the temperature is above the threshold value, magnetic domains are coupled from the storage layer to the read-out layer. For temperatures above the threshold temperature the following condition is satisfied:
H_{S}+Hₑₓₜ≧H_{c} (1)
where H_{S} is the stray field of the storage layer at the read-out layer, Hₑₓₜ is the externally applied field, and H_{c} is the coercive field of the read-out layer. The spatial region where this copying occurs is called the ‘copy window’. The size w of the copy window is very critical for accurate read-out. When the condition (1) is not fulfilled (copy window size w=0), no copying takes place at all. On the other hand an oversized copy window will cause overlap with neighbouring bits (marks) and will lead to additional ‘interference peaks’. The size of the copy window depends on the exact shape of the temperature profile (that is, the exact laser power, but also the ambient temperature), the strength of the externally applied magnetic field, and on material parameters that may show short- (or long-) range variations.

The laser power used in the read-out process should be high enough to enable copying. On the other hand, a higher laser power also increases the overlap of the temperature-induced coercivity profile and the stray field profile of the bit pattern. The coercivity H_{c} decreases and the stray field increases with increasing temperature. When this overlap becomes too large, a correct read-out of a space is no longer possible due to false signals generated by neighboring marks. The difference between this maximum and the minimum laser power determines the power margin, which decreases strongly with decreasing bit length.

In MAMMOS, the synchronization of the external field with the recorded data is crucial. Accurate clock recovery is possible by using, for example, datadependent field switching. Furthermore, the range of allowed laser powers for correct read-out at high densities is quite small. However, this sensitivity to read-out laser power can also be exploited to achieve an accurate power control loop, that is, dynamic copy window control, using the read-out signals from the recorded data. This is done by adding a small modulating component (wobbling) to the laser power, thus inducing timing shifts of the MAMMOS signals. By, for example, lock-in detection of these shifts, any change in laser power, external field, or ambient temperature can be corrected to keep the copy window constant. In this way, an accurate and robust read-out is possible, allowing much higher densities than with a conventional system. This increase/decrease (wobbling) may be applied with a predefined change pattern, for example a periodic pattern with small amplitude. The wobbling causes the copy window to increase or decrease in size synchronously with the wobble frequency. When the copy window increases in size, the next transition will appear somewhat earlier than expected. On the other hand, when the copy window decreases in size, the next transition will be delayed slightly. This is indicated by the phase error amplitude. This phase error amplitude is a direct measure for the read-out parameter due to a non-linear square-root-like dependence of the copy window size on the read-out parameter. To obtain an absolute error signal that can be used as an input for the copy window control loop, the control method requires a suitable reference setpoint, which corresponds to the optimum read-out parameters, for example external field and/or laser power.

A major step in capacity has been achieved by using a dual-layer disk. In conventional magneto-optical systems, different kinds of duallayer approaches are known. In most cases, the two storage layers are closely spaced (or even directly connected, that is, exchange coupled), within the focus depth of the objective lens. Read-out of the different layers is based on a difference in Kerr rotation and ellipticity. For example, the interference layers are adjusted such that a first layer only gives Kerr rotation, while a second layer only gives Kerr ellipticity. Sometimes, different wavelengths are used to improve this effect. An alternativer way to read both layers is a kind of multi-level approach: depending on the data in the different layers four different signal levels (for example Kerr rotation) are detected (++, +, −,−−). However, the signal-to-noise-ratio for the medium levels (+, −) is lower.

Several options are possible for recording in the different layers. The magnetic properties may be adjusted so that one layer has a higher Curie temperature (Tc) than the other. In this way, the low-Tc layer can be written at a lower laser power without affecting the high-Tc layer. Both layers are affected at a high laser power. Alternatively to or in combination with the above methods, differences in field sensitivity are used. Here the sign and amplitude of the applied magnetic field determine the switching of both layers. For example, a first layer always follows the sign of the field, whereas a second layer opposes the field when it is below a certain amplitude and follows the field when the amplitude is large enough. In this way, both layers are written in a single pass. To achieve this behavior, the second layer is exchange-coupled to another magnetic layer, for example a PtCo multilayer or the first storage layer.

Although dual-layer MO is certainly possible, an extension to dual-layer MAMMOS is far from trivial. In the MAMMOS process, a storage layer and a read-out layer are required. Together these layers are at least 30-70 nm thick, which makes the transmission for signals from a read-out layer below this set of layers too low for detection.

Documents WO99/39341 and JP2002-298465 disclose dual-layer MAMMOS discs for reproducing multi-value signals generated by a combination of stray fields of first and second storage layers in a common read-out layer. Both storage layers are independently read in succession by means of a laser power adapted to heat the non-read storage layer to its compensation temperature so as to ensure that only the mark of the read storage layer is copied to the read-out layer. Separate read-out of the different storage layers is thus possible by choosing the corresponding read-out laser power. This laser power should be such that the temperature of the layer that is not being read is brought close to its compensation temperature, thus eliminating any stray field influence on the read-out process.

As was noted above, the laser power and the applied external field should be carefully balanced by copy window control procedures to enable the highest storage densities the read-out process of a single-layer disk. Despite the required tight control (typically around 1% in laser power), there is quite some room to balance laser power against external field: when the field is somewhat too low, a higher laser power can still give a correct read-out, and vice versa.

However, this is different in the dual-layer case, because now the storage layer must reach a predetermined absolute temperature, although it is within more tolerant limits of about ±10° C.

Ideally, every disk and every drive would have perfectly matched properties, so that the read power levels in the drive would correspond to the compensation temperatures of the different storage layers. this is not the case, however, for several reasons. Apart from contamination of the drive optics (dust) and for example degradation of the laser, the optical (reflectivity, absorption), thermal (conductivity, heat capacity), and magnetic (T_{co} changes by up to 80 K/at % composition change) properties may change from disk to disk and over the radius of a disc (non-uniformity in thickness and/or composition). Proper calibration of the read-out parameters corrects for the differences between drives, disks, and disk radii, and allows wider tolerances. Active copy window control is important, however, as it is in read-out of single storage layer MAMMOS disks, to realize robust read-out at the highest densities. For dual storage layer MAMMOS, laser power and external field cannot be exchanged freely as in single-layer MAMMOS. This is because the read-out temperature has to be kept quite close to the compensation temperature of the storage layer not being read, in order to prevent ‘crosstalk’ from this layer.

It is an object of the present invention to provide a method and an apparatus by means of which a proper read-out power control can be achieved.

This object is achieved by providing a reading apparatus as claimed in claim 1 and by providing a reading method as claimed in claim 13.

Accordingly, a fast and efficient power control mechanism can be achieved independent by of a copy window control which is preferably performed by changing the strength of the applied external magnetic field. Moreover, crosstalk between the first and second storage layers can be reduced by keeping the read-out temperature close to the compensation temperature of the other storage layer which is not read.

The proposed procedure may be used during a read-out operation based on a reflected power, read-out error, or phase error.

The parameter may be determined based on a weighted average over parameters derived from at least two of the following quantities: the reflected radiation power, the error rate, and the phase error.

Furthermore, the radiation power may be controlled using a mix of fast and slow power correction mechanisms. In this way, high speed and stability of the power control are combined.

A value of at least one predetermined read-out parameter may be stored before detection of a local deviation, and restored as an initial setting when the end of the detected local deviation is detected.

While the copy window control loop is active to keep the copy window size constant with high accuracy, the laser power can be adjusted by a separate control mechanism to keep the temperature at the magnetic layers constant, despite the presence of disc variations. The required accuracy of the latter mechanism is less than for the copy window control, because a temperature deviation of (less than) typically 10° C. is still acceptable to prevent crosstalk. The copy window control loop can easily deal with the effects of the residual temperature ‘error’ on the copy window size, preferably by adjusting the field amplitude. However, response times should be fast.

The parameter may be derived from at least one of the following quantities: a radiation power reflected at the recording medium, an error rate of a read-out signal obtained from the read-out operation, and a phase error obtained from a copy window control circuit during the read-out operation. Thus, laser power can be adjusted on the basis of on a detection of a local disc variation or contamination which, if uncorrected, could lead to a local temperature change accompanied by a change in copy window size, and by a temporary crosstalk between the two storage layers in the case of a dual storage layer recording medium. In particular, combinations of the above implementations for deriving the control parameter may be used to improve the response time and stability of the read-out control.

When a recording medium with two storage layers is used, it can thus be assured that the first storage layer is read independently of the second storage layer. The first value of the radiation power is determined by the compensation temperature of the second storage layer, and the second value of the radiation power is determined by the compensation temperature of the first storage layer.

Other advantageous further developments are defined in the dependent claims.

In the following, the present invention will be described on the basis of embodiments with reference to the accompanying drawings, in which:

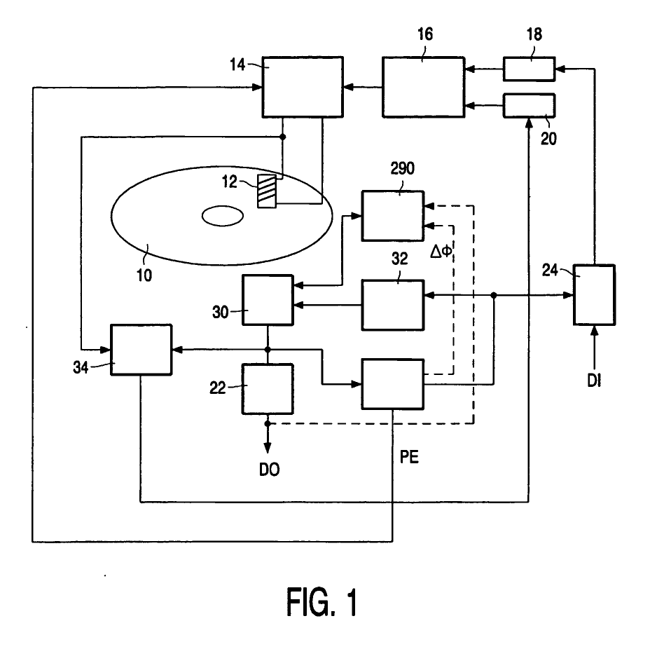

FIG. 1 is a diagram of a magneto-optical disc player according to an embodiment of the invention,

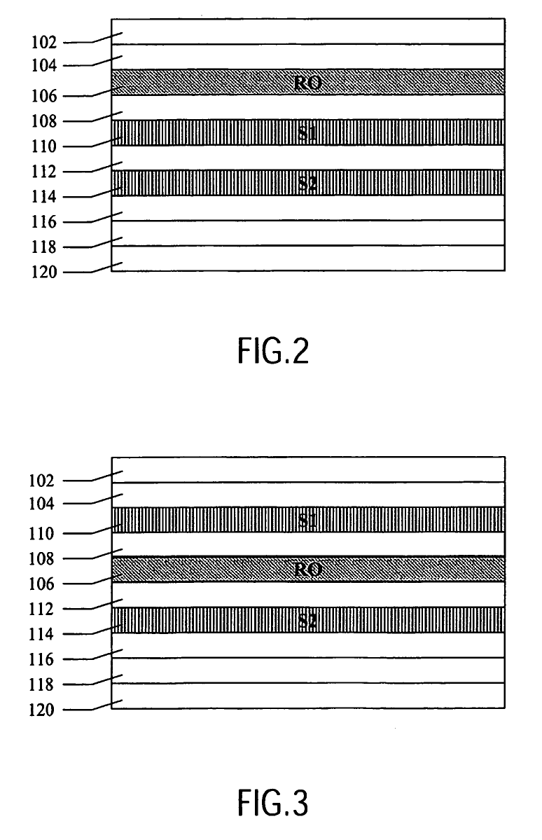

FIG. 2 shows a layer structure of a dual storage layer MAMMOS disc according to a first embodiment,

FIG. 3 shows a layer structure of a dual storage layer MAMMOS disc according to a second embodiment,

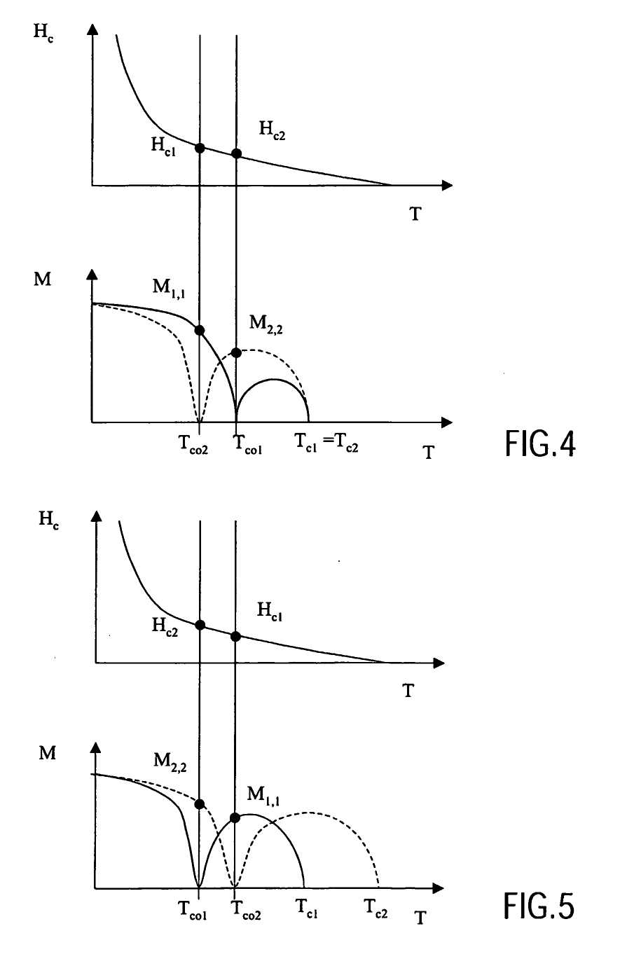

FIG. 4 shows diagrams indicating temperature dependencies between a read-out layer coercivity and storage layer magnetizations for a first read-out type,

FIG. 5 shows diagrams indicating temperature dependencies between a read-out layer coercivity and storage layer magnetizations for a second read-out type,

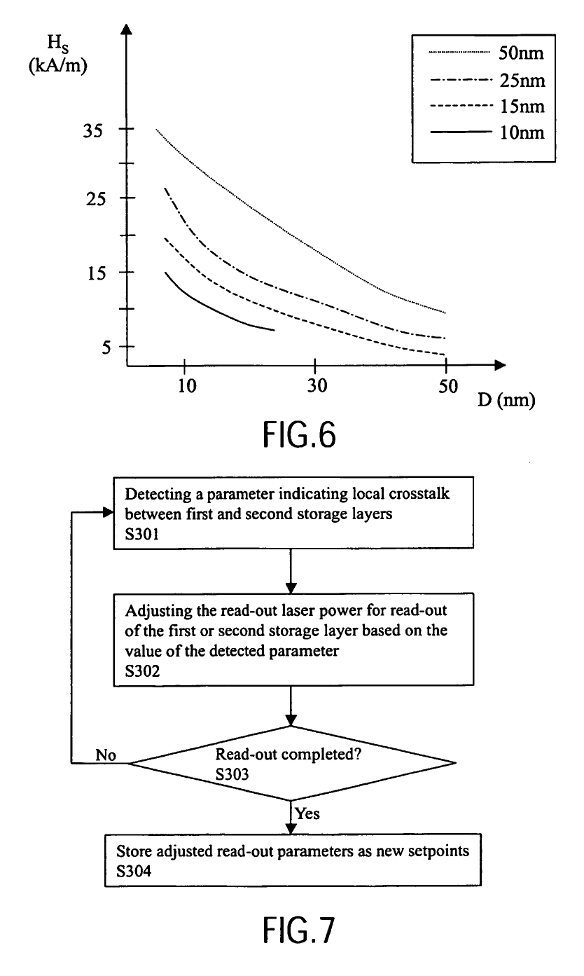

FIG. 6 shows a diagram indicating the stray field amplitude in the read-out layer as a function of the distance between the storage and read-out layers for different storage layer thicknesses,

FIG. 7 shows a flow diagram of a laser power adjustment procedure according to an preferred embodiment, and

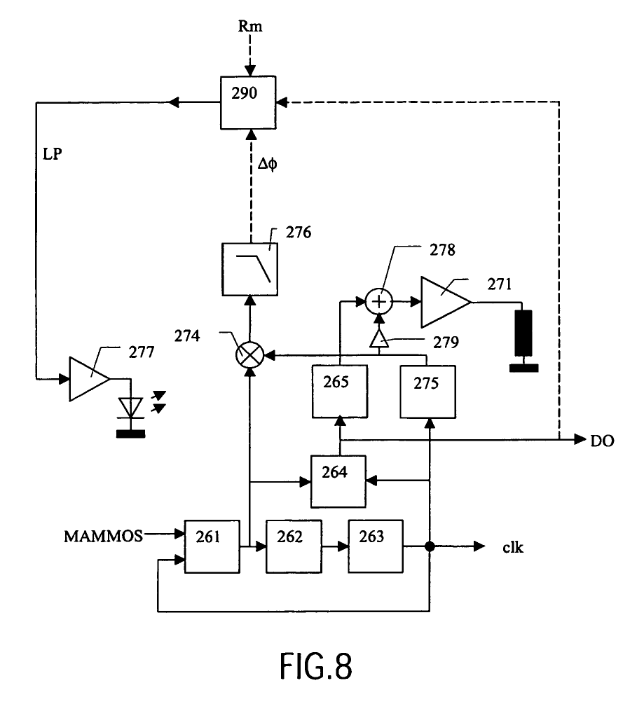

FIG. 8 shows a block diagram of a combined power control and copy window control circuitry according to an preferred embodiment.

FIG. 1 schematically shows the construction of the MAMMOS disc player according to an preferred embodiment. The disc player comprises an optical pick-up unit 30 having a laser light radiating section for irradiation of a dual storage layer magneto-optical recording medium or record carrier 10, such as a dual storage layer MAMMOS disc, with light that has been converted, during recording, into pulses with a period synchronized with code data. The player further comprises a magnetic field applying section comprising a magnetic head 12 that applies a magnetic field in a controlled manner during recording and playback on the magneto-optical disc 10. In the optical pick-up unit 30, a laser is connected to a laser driving circuit that receives recording and read-out pulses from a recording/read-out pulse adjusting unit 32 so as to thereby control the pulse amplitude and timing of the laser of the optical pick-up unit 30 during a recording and read-out operation. The recording/read-out pulse adjusting circuit 32 receives a clock signal from a clock generator 26 that comprises a PLL (Phase Locked Loop) circuit.

It is noted that, for reasons of simplicity, the magnetic head 12 and the optical pickup unit 30 are shown on opposite sides of the disc 10 in FIG. 1. Preferably, they should be arranged on the same side of the disc 10.

The magnetic head 12 is connected to a head driver unit 14 and receives code-converted data via a phase adjusting circuit 18 from a modulator 24 during recording. The modulator 24 converts input recording data D1 into a prescribed code.

During playback, the head driver 14 receives a timing signal via a playback adjusting circuit 20 from a timing circuit 34, wherein the playback adjusting circuit 20 generates a synchronization signal for adjusting the timing and amplitude of pulses applied to the magnetic head 12. The timing circuit 34 derives its timing signal from the data read-out operation. Thus, a data dependent field switching can be achieved. A recording/playback switch 16 is provided for switching or selecting the respective signal to be supplied to the head driver 14 during of recording and during of playback.

Furthermore, the optical pick-up unit 30 comprises a detector for detecting laser light reflected from the disc 10 and for generating a corresponding reading signal applied to a decoder 28 that is arranged to decode the reading signal so as to generate output data DO. Furthermore, the reading signal generated by the optical pick-up unit 30 is supplied to a clock generator 26 in which a clock signal obtained from embossed clock marks of the disc 10 is extracted or recovered, and which supplies the clock signal for synchronization purposes to the recording pulse adjusting circuit 32 and to the modulator 24. In particular, a data channel clock may be generated in the PLL circuit of the clock generator 26. It is noted that the clock signal obtained from the clock generator 26 may also be supplied to the playback adjusting circuit 20 so as to provide a reference or fallback synchronization which may support the data-dependent switching or synchronization controlled by the timing circuit 34.

In the case of data recording, the laser of the optical pick-up unit 30 is modulated with a fixed frequency corresponding to the period of the data channel clock, and the data recording area or spot of the rotating disc 10 is locally heated at equal distances. Additionally, the data channel clock output by the clock generator 26 controls the modulator 24 to generate a data signal with the standard clock period. The recording data are modulated and code-converted by the modulator 24 to obtain a binary run length information corresponding to the information of the recording data.

In FIG. 1, a timing circuit 34 is provided for supplying a data-dependent timing signal to the playback adjusting circuit 20. Alternatively, the data-dependent switching of the external magnetic field may be achieved by supplying the timing signal to the head driver 14 so as to adjust the timing or phase of the external magnetic field. The timing information is obtained from the (user) data on the disc 10. To achieve this, the playback adjusting circuit 20, or the head driver 14, is adapted to provide an external magnetic field that is normally in the expansion direction. When a rising signal edge of a MAMMOS peak is observed by the timing circuit 34 at an input line connected to the output of the optical pickup unit 30, the timing signal is supplied to the playback adjusting circuit 20 such that the head driver 14 is controlled to reverse the magnetic field after a short time so as to collapse the expanded domain in the read-out layer, and shortly after that to reset the magnetic field to the expansion direction. The total time between the peak detection and the field reset is set by the timing circuit 34 to correspond to the sum of the maximum allowed copy window and one channel bit length on the disc 10 (times the linear disc velocity).

Furthermore, a dynamic copy window control function is provided by applying a modulation, for example a wobble or change pattern, to the head driver 14 and continuously measuring the size w of the copy window, using information from the detected data signal in the read mode. If the wobble frequency lies above the bandwidth of the clock recovery PLL circuit of the clock generator 26, the phase error of this PLL circuit can be used to detect the small deviation or phase error with respect to the expected transition position.

The frequency deviation of the introduced wobble or change pattern should have a zero average value. However, the amplitude Δφ of the phase error obtained here cannot be used yet as an absolute error signal for laser power control as only the absolute scale is known, but no reference (zero or offset) is present. That is, only changes in the size of the copy window can be measured. To circumvent this problem, the derivative of the copy window size w a function of temperature can be measured to obtain control information for controlling the size w of the copy window. Due to the fact that the derivative or amount of change of the copy window size w directly leads to the phase amplitude Δφ, the amplitude Δφ of the detected phase error corresponds to the derivative and can thus be used for copy window control. The deviation from a predetermined setpoint can then be used as a control signal PE for controlling the strength of the external magnetic field at the head driver 14.

Any changes in the size of the copy window due to changes in parameters, such as coil-disc distance, ambient temperature, etc., are counteracted by the controlled external magnetic field.

In the player shown in FIG. 1, a read-out control circuit 290 is provided, which is adapted to determine or adjust the laser power of the optical pickup unit 30. According to the preferred embodiment, the laser power is controlled by the read-out control circuit 290 independently of the field-based copy window control at the clock generator 26. In particular, the read-out control circuit determines a parameter that is a suitable or reliable indicator for the presence and/or strength of a local deviation in the read-out characteristic of the MAMMOS disc 10.

FIG. 2 shows a layer structure of a dual storage layer MAMMOS disc according to a first example. The solution proposed here is to use only one read-out layer 106 to reproduce the information in the different storage layers 110, 114 arranged one on top of the other. The read-out layer 106 is arranged on top of the two storage layers 110, 114 in the direction of the laser incident side. Recording of these storage layers 110, 114 is possible by any of the methods described in the prior art, for example those initially mentioned. The main difficulty is to fulfill the MAMMOS read-out requirements on the balance of coercivity, stray field (from storage layer at the read-out layer), and applied external field, i.e. for both storage layers 110, 114. For MAMMOS reproduction of a mark bit, the magnetic properties of the storage and read-out layers 106, 110, 114, and the laser power for read-out are chosen such that the sum of the stray field generated by the mark and the applied external field is just greater than the coercivity of the read-out layer, that is, H_{S}+Hₑₓₜ>H_{c}. As both two storage layers 110, 114 produce a stray field, the equation can be modified as follows:
H_{S1}+H_{S2}+Hₑₓₜ>H_{c}, (2)
wherein H_{S1} and H_{S2} designate respective stray field strengths of the storage layers 110, 114.

To allow separate read-out of both storage layers without influencing of the respective other layer, the layer structure shown in FIG. 2 is proposed according to the first example of the dual storage layer MAMMOS disc. Starting from the laser incidence side, the generic layer stack comprises an optional first cover or substrate 102, a first dielectric layer 104 made of, for example, SiN, SiO₂, and the read-out layer 106, preferably made of GdFeCo or GdFe with a thickness of 10-30 nm, preferably 20 nm. Furthermore, a non-magnetic spacer layer 108 with a thickness of 1-15 nm, preferably 5 nm, and made of e.g. SiN or Al is provided between the read-out layer 106 and the first storage layer 110. The first storage layer 110 has a thickness of preferably 8-35 nm and is preferably made of TbFeCo possibly with additions of rare earth, transition or other metals, nonmetals such as Si, etc. An optional intermediate layer 112 is arranged between the first storage layer 110 and the second storage layer 114. The intermediate layer 112 may be a non-magnetic dielectric or metal spacer layer with a thickness of 1-15 nm, preferably 5 nm, or a Ru exchange coupling layer with a thickness of 0.1-5 nm. As a further alternative, no intermediate layer 112 may be used at all, such that a direct exchange coupling is provided between the first and second storage layers 110, 114.

The second storage layer 114 may have a thickness of preferably 10-100 nm and may be preferably made of TbFeCo possibly with additions as described above in connection with the first storage layer 110. Additionally, an optional exchange bias layer 116, for example a multi layer of PtCo or PdCo, amorphous RE-TM material, etc. may be provided, followed by a second dielectric layer 118 made of SiN or SiO₂ and including an optional heat sink. Finally, an optional second substrate or cover 120 is provided.

The first and second storage layers 110 and 114 should have at least the following magnetic properties:
ferrimagnetic with different compensation temperatures T_{co1} and T_{co2}, both below the respective Curie temperatures T_{c1} and T_{c2};
internal drive temperature T_{ambient} (<˜70° C.)<T_{co1}≠T_{co2}<min (T_{c1}, T_{c2});
read-out temperatures T_{read-out1}=T_{co2} and T_{read-out2}=T_{co1}, while the differences should be smaller than approximately 10° C. to avoid interlayer crosstalk. Larger differences will limit the possible storage density.

FIG. 3 shows a schematic layer structure of a dual storage layer MAMMOS disc according to a second example. In this second example, the read-out layer 106 is placed between the first and second storage layers 110, 114. In that case, the first storage layer 110 which is closest to the laser incidence side should be thinner than approximately 10 nm and the dielectric layer(s) 104, 112 (optical interference) should be adjusted to maximize the Kerr signal from the read-out layer 106 while suppressing that from the upper first storage layer 110.

FIGS. 4 and 5 show diagrams indicating temperature dependencies between a read-out layer coercivity H_{c} and storage layer magnetizations M for respective first (FIG. 4) and second (FIG. 5) media types. The magnetization curves relating to the first storage layer 110 are indicated by solid lines, and the magnetization curves relating to the second storage layer 114 are indicated by dashed lines. M_{1,1} means magnetization of the first storage layer 110 at the read-out temperature of the first storage layer 110, which is equal to the compensation temperature T_{co2} of the second storage layer 114. Similarly, M_{2,2} means magnetization of the second storage layer 114 at the read-out temperature of the second storage layer 114, which is equal to the compensation temperature T_{co1} of the first storage layer 110.

According to the proposed read-out scheme, read-out of the first storage layer 110 is achieved by having the read-out control circuit 290 of FIG. 1 adjust the laser power to heat the second storage layer 114 to its compensation temperature T_{co2}. Since the effective magnetization M vanishes at this temperature, the stray field contribution HS₂ from the second storage layer 114 also becomes zero. Thus, only the stray field contribution H_{S1} generated by the bits in the first storage layer 110 will trigger the MAMMOS copy and expansion read-out process. The same principle can be used for read-out of the second storage layer 114, i.e., the read-out control circuit 290 adjusts or changes the laser power to heat the first storage layer 110 to its compensation temperature T_{co1} which will suppress H_{S1} and allow separate or independent read-out of the data in the second storage layer 114. This simple layer selection method does not require any modifications to the optics of the optical pickup unit 30, i.e., no focus jumps, aberration correction, etc., and only very minor adjustments in the electronics are needed compared with a single-layer system.

From this read-out method it is clear that the read-out temperatures and thus both compensation temperatures should be above the (maximum) ambient temperature. Both compensation temperatures should also be below the lowest of the storage layers' Curie temperatures, because a read-out temperature close to (or higher than) the Curie temperature may disturb or erase the data in the respective layer, especially when magnetic fields are applied.

The diagrams of FIG. 4 relate to the first read-out type of exchange-coupled storage layers with different field sensitivities, where the first storage layer 110 is read out at a lower temperature T_{read-out1}=T_{co2} while the second storage layer 114 is read out at a higher temperature T_{read-out2}=T_{co1}. The Curie temperatures T_{c1} and T_{c2} of the first and second storage layers 110, 114 are equal.

The diagrams of FIG. 5 relate to the second read-out type of separate, de-coupled storage layers with different Curie temperatures, where the first storage layer 110 is read out at a higher temperature T_{read-out1}=T_{co2} while the second storage layer 114 is read out at a lower temperature T_{read-out2}=T_{co1}. Here, the Curie temperature T_{c1} of the first storage layer 110 is lower than the Curie temperature T_{c2} of the second storage layer 114.

To enable the MAMMOS read-out process, a number of additional conditions should be fulfilled by the combination of layer stack and magnetic properties of the read-out and storage layers 106, 110, 114:
the external magnetic field Hₑₓₜ used during read-out should be sufficiently strong to drive the domain expansion process. For reasons of simplicity, it is preferable (but not necessary) that Hₑₓₜ is the same for both storage layers. Practical field strengths are between 8 and 16 kA/m, but may be lower or higher;
at each of the read-out temperatures, the coercivity of the read-out layer 106 (H_{c1} for read-out of the first storage layer 110, H_{c2} for read-out of the second storage layer 114) should be greater than the applied external field, that is, H_{c1}>Hₑₓₜ₁ and H_{c2}>Hₑₓₜ₂, or min(H_{c1}; H_{c2})>Hₑₓₜ. If this condition is not fulfilled, the read-out process will no longer be determined only by the data in the storage layer, that is, the read-out layer's magnetization will ‘follow’ the applied magnetic field instead of the data.
the minimum strength of the stray fields generated by the data in the storage layers 110, 114 which is required in the read-out layer 106 is determined by the difference H_{c}-Hₑₓₜ. Thus, H_{S1}>H_{c1}−Hₑₓₜ₁ and H_{S2}>H_{c2}−Hₑₓₜ₂. These stray fields depend on the respective magnetizations M_{1,1} and M_{2,2} of the storage layers 110, 114 at their read-out temperatures (as explained earlier, M_{1,2} and M_{2,1} should be close to zero), the respective thicknesses t1 and t2 of the storage layers 110, 114, and the respective distances D1 and D2 between the storage layers 110, 114 and the read-out layer 106.

FIG. 6 shows a diagram indicating the stray field amplitude H_{S} in the read-out layer 106 generated by bits in the storage layer as a function of the distance between the storage and read-out layers for different storage layer thicknesses t ranging from 10 nm (solid line) to 50 nm (dotted line) and for a magnetization M=100 kA/m. As shown in FIG. 2, a thicker layer gives a stronger stray field H_{S}, but this field rapidly decreases at a greater distance.

Assuming realistic values for the magnetization M, this means that in the first example of FIG. 2 the upper, first storage layer 110 should preferably be thinner than the lower, second storage layer 114. To enable reliable and high-density recording, the storage layers 110, 114 should have a thickness between 8 and 100 nm. Thicker layers are possible, but at the cost of some density. Typical values for the first storage layer 110 may be between 10 and 35 nm, and for the second storage layer 114 between 10 and 100 nm.

All layers in FIGS. 2 and 3 may be sputtered using conventional equipment, while only a few additional layers (typically 1 to 3) are needed compared with a single-layer MAMMOS disk. There is no need for a spin-coated or PSA (Pressure Sensitive Adhesive) spacer layer with tight tolerances and related spherical aberration problems. Moreover, as was noted above, no modifications are required to the optical system, only minor modifications to electronics, i.e. to the read-out control circuit 290 for switching the laser power for read-out of the different storage layers 110, 114. Assuming an allowed residual stray field due to a non-zero magnetization of 1 kA/m, allowed deviations were estimated in the order of ±10° C. Compared with the read-out power margin of ˜1%=>1.5° C., this is quite tolerant. Such allowed deviations also pose no problems to the manufacture of such disks.

In the following, examples of stack designs of the above first and second media types as shown in FIGS. 4 and 5 are given for λ=405 nm and a numerical aperture NA=0.85:

For the first read-out type (FIG. 4):

45 nm SiN

20 nm GdFeCo

5 nm SiN

20 nmTbFeCo,1

5 nm SiN

50 nm TbFeCo,2

20 nm CoPt multilayer

20 nm SiN

30 nm Al alloy

substrate

This stack design according to the first read-out type leads to the following read-out parameters: T_{co1}=150° C., T_{co2}=130° C., T_{c1}=T_{c2}=200° C., H_{c1}=35 kA/m, M_{1,1}=90 kA/m, H_{c2}=25 kA/m, M_{2,2}=50 kA/m, and Hₑₓₜ=16 kA/m.

For the second read-out type (FIG. 5):

45 nm SiN

20 nm GdFeCo

5 nm SiN

10 nmTbFeCo,1

5 nmSiN

50 nm TbFeCo,2

20 nm SiN

30 nm Al alloy

substrate

This stack design according to the second read-out type leads to the following read-out parameters: T_{co1}=150° C., T_{co2}=130° C., T_{c1}=200° C., T_{c2}=250° C., H_{c1}=25 kA/m, M_{1,1}=70 kA/m, H_{c2}=35 kA/m, M_{2,2}=90 kA/m, and Hₑₓₜ=16 kA/m.

Other variations, for example with switched low and high temperatures are also possible.

A good solution for read-out control may be to use the external field Hₑₓₜ for the wobbling to measure the phase shifts for the copy window control function, and to use the laser power as the controlled parameter of the read-out control circuit 290. Assuming a stable coil current source, this would automatically keep the internal temperature constant. However, nearly instantaneous correction of the temperature deviations induced by realistic contamination requires a very large gain setting in the control loop, which may therefore become unstable. The read-out control circuit 290 is thus arranged to adjust the laser power level independently of the copy window control loop, based on the detection of a local deviation such as dust or a fingerprint. Thus, while the copy window control loop is active in keeping the size of the copy window constant with high accuracy, the laser power is adjusted by a separate control mechanism in the read-out control circuit 290 to keep the temperature at the magnetic storage layers 110, 114 constant, despite the presence of e.g. fingerprints. The required accuracy of the latter mechanism is less than for the copy window control, because a temperature deviation of (less than) typically 10° C. is still acceptable to prevent crosstalk. The copy window control loop can easily deal with the effects of the residual temperature ‘error’ on the copy window size, preferably by adjusting the field amplitude. Fast response times, however, are crucial.

Preferably, the copy window control is carried out with the external field Hₑₓₜ being used both for the wobbling, i.e., small amplitude modulation at a frequency above the PLL bandwidth, and for the amplitude correction. However, a control using the laser power for wobbling and/or amplitude correction is explicitly not excluded.

FIG. 7 is a flow diagram of a laser power adjustment procedure according to an preferred embodiment. A predetermined parameter indicating a local deviation in the read-out characteristic is detected or determined in step S301. Then, the read-out laser power for reading the first or second storage layer is adjusted in step S302 on the basis of the detected or determined parameter e.g. to prevent crosstalk between the first and second storage layers 110, 114. Steps S301 and S302 are repeated until it is determined in step S303 that the read-out operation is completed. Then, in step S304, read-out parameters including the adjusted read-out laser power are stored as new setpoints or default values.

According to a first implementation option, the detection step S301 may be based on a measurement of the reflected laser power, for example from phase change read-out, used to detect local contamination as the above parameter and adjust the laser power accordingly. For example, the initial reflected power Ri at a laser power of Pi (for example after initial calibration) is measured and continuously monitored. Any change in the subsequently measured reflected laser power Rm must be due to a change in transmission, for example, owing to a fingerprint. Since the light goes in and out of the disk 10 (two passes), the ratio Rm/Ri is proportional to the square of the temperature T. To maintain the same temperature in the disk 10, the laser power P must be adjusted according to the following equation:
P=Pi (Ri/Rm)ˆ(1/2) (3)

It is to be noted that only one pass is used to heat the storage layer. If this method is sufficiently fast and accurate to within less than +/−10° C., the copy window control loop can keep the window constant with the required accuracy.

According to a second implementation option, a deviation from the calibrated read-out parameters, for example due to a fingerprint, leading to lower transmission and lower temperature gives rise to crosstalk from the other storage layer. This leads to read-out errors which appear with a frequency much higher than the wobble frequency and which are ‘random’ in nature, i.e., not just either more or fewer peaks. The phase error signal from the copy window control loop will become noisier, but may still be good enough to keep w constant. Even then, the crosstalk causes erroneous signals and thus an increased error rate. Clearly, such an increase in error rate is related to the occurrence of a local deviation. Hence, monitoring the error rate in combination with copy window control can provide a useful input parameter for the detection step S301 to control the laser power at the read-out control circuit 190. In particular, the read-out laser power can be adjusted to minimize the error rate.

For rapid, possibly iterative, adjustment, a power correction ΔP function or look-up table may be provided with ΔP settings versus error rate and laser power. The error rate may be obtained, for example, from existing ECC blocks or from simple methods like a cyclic redundancy check (CRC). Since major corrections may be required in very short times, the speed and robustness of the error rate detection is important.

A third implementation option may be to use the phase error signal from the copy window control loop also for the detection of a local deviation. Normally, when the copy window control loop is active, the occurrence of e.g. a fingerprint will give rise to a sudden increase in the controlled read parameter (and a decrease at the end of the fingerprint). Since read control in the absence of local deviations as meant here (dust, prints) can be relatively slow and gradual (for example to compensate for any temperature or laser power drift), the detection of a sudden change in phase error (for example when the time-derivative of the phase error is above a prescribed value) indicates the presence or end of such a deviation. When such a change is detected, the copy window control loop should be frozen, i.e. the controlled read-out parameter (Hₑₓₜ) is kept fixed, while the wobbling continues in order to keep monitoring the phase error. At the same time, the laser power is adjusted to correct the deviation. When the control is stable again, e.g. time derivative below prescribed value, the laser power is again fixed and normal copy window control is resumed.

Combinations of (parts of) the above implementation options can be used to double-check large ΔP corrections. For example, if the different methods suggest different corrections due to noise, large gain, etc., it is beneficial to use a correction that is a weighted average over the different methods to improve the stability, while not sacrificing rapid response times. An alternative possibility is to use a mix of fast (but somewhat unstable) and slow (but reliable) implementations. In the case of consistent results, the ‘fast’ correction is used, while otherwise the ‘slow’ correction is used. In this way, high speed and stability are combined.

A separate option may be to store read-out parameters before detection of a deviation, and restore these values as initial settings when the end of the deviation is detected.

FIG. 8 shows a more detailed functional block diagram of the combined read-out power and copy window control functionality with the control signals of the read-out control circuit 290. Blocks 261 to 265 constitute the PLL part, and blocks 274 and 276 constitute a lock-in detection function, wherein multiplication of the signal by a modulation frequency causes sum and difference frequencies, whereupon low-pass filtering gives a DC value that is the equivalent of lock-in. Dashed lines indicate the corresponding read-out power control signals of the preferred embodiment.

In FIG. 8, the detected MAMMOS run length signal output from the pickup unit 30 of FIG. 1 is supplied to a phase detector 261 of the PLL circuit of the clock generator 26 of FIG. 1, in which the phase of the run length signal is compared with the phase of an output signal of a voltage controlled oscillator (VCO) 263 of the PLL circuit. Additionally, the feedback signal is supplied to a clock divider 275 that divides the clock frequency and supplies it to a modulation circuit 279 for laser power modulation. The output of the phase detector 261, which corresponds to the phase difference between the run length signal and the feedback signal, is supplied to a loop filter 262 for extracting the desired frequency to be phase-controlled in the PLL circuit. The recovered output clock at the VCO 263 is also supplied to a bit detector 264 which detects the presence of a bit in the output signal of the phase detector 261. The detected bit information is outputted as the output data DO and supplied together with the recovered output clock to a field switching control unit 265 which controls a coil driver 271 of the field coil of the magnetic head 12 for generating the magnetic field so as to implement the data-dependent field switching function. The field modulation (wobbling) at the output of the modulation circuit 279 is added by an adding circuit 278 and thus also causes the pulse positions to shift in dependence on the sign of the modulation. This means that the average pulse position in subsequent low periods and in subsequent high periods is no longer DC-free.

The data-dependent field switching causes, the high-frequency components of the phase error from the phase detector 261 to contain the pulse positions of the reproduced data. When the strength of the external magnetic field Hₑₓₜ is modulated by the modulation output of the modulation circuit 279 at a frequency M times lower than the bit clock, the phase error from the phase detector 261 contains synchronous, low-frequency laser power error information, which is demodulated by a demodulation or mixing circuit 274, to which the laser modulation signal at the output of the clock divider 275 is supplied, and extracted using a low-pass filter 276. The combination of the mixing circuit 274 and the low-pass filter 276 is the equivalent of a band-pass filter around the modulation frequency, i.e., ‘lock-in’ detection.

During an initial power setting or calibration, the output data DO can be used as a control input for deriving a correlation or measuring an error as a parameter for adjusting or setting the read-out laser power. The adjustment is performed by supplying a power control signal LP via a driving amplifier 277 to the laser diode of the pickup unit 30 of FIG. 1.

In the above first implementation option of the power control procedure according to FIG. 7, a measured value Rm of the reflected power can be supplied from the optical pickup unit 30 to the read-out control circuit 290 which derives the power control signal LP, for example, from a look-up table or the like.

In the above second implementation option of the power control procedure according to FIG. 7, the output data DO relating to the read-out signal of first and second known data patterns which may be pre-recorded at same locations, one above the other, on the respective storage layers 110, 114 can be used as a control input for the read-out control circuit 290 which derives the power control signal LP from an amount of errors in the output data, for example based on a look-up table or the like.

Finally, in the above third implementation option, the extracted phase error signal can be then used as a control input for power control at the read-out control circuit 290. The derived power control signal LP is supplied via a driving amplifier 277 to the laser diode of the pickup unit 30 of FIG. 1.

As was noted above, the first to third implementation options may be used in combination to improve power control efficiency.

It is noted that the present invention may be applied to any reading system for domain expansion magneto-optical disc storage systems for reading from one or multiple storage layers. Layer stacks and read-out methods similar to those proposed above may also be used in systems with, for example, card-shaped media, non-moving, stationary read-out principles based on arrays of optical spots and/or thin-film magnetic sensors (such as GMR or TMR), or alternative local heating methods such as, for example, addressable crossed metal wires inside or brought close to the media.

The read-out control circuit 290 may be implemented by a hardware circuit or by a software-controlled analog or digital processing circuit, or may be incorporated as a new routine in an existing control program for controlling the disc player. The embodiments may thus vary within the scope of the attached claims.

1. A reading apparatus for reading from a magneto-optical recording medium (10) comprising at least one storage layer (S1, S2) and a read-out layer (RO), wherein an expanded domain leading to a read-out pulse is generated in said read-out layer (RO) by copying of a mark region from said at least one storage layer to said read-out layer through heating by a radiation power and with the help of an external magnetic field, said apparatus comprising:
determination means (290) for determining a parameter indicating the presence or strength of a local deviation in a read-out characteristic of said recording medium (10), and
control means (290) for controlling said radiation power on the basis of based on said determined parameter.

2. A reading apparatus according to claim 1, wherein said control means (290) is adapted to perform the radiation power control independently of a copy window control.

3. A reading apparatus according to claim 2, wherein said copy window control is a field-based or a power-based control.

4. A reading apparatus according to claim 1, wherein said determination means (290) is adapted to derive said parameter from at least one of the following quantities: a radiation power reflected at said recording medium (10), an error rate of a read-out signal obtained from said read-out operation, and a phase error obtained from a copy window control circuit during said read-out operation.

5. A reading apparatus according to claim 4, wherein said determination means (290) is adapted to determine said parameter based on a weighted average over parameters derived from said reflected radiation power, said error rate, or said phase error.

6. A reading apparatus according to claim 1, wherein said control means (290) is adapted to control said radiation power using a mix of fast and slow power correction mechanisms.

7. A reading apparatus according to claim 1, wherein said control means (290) is adapted to store a value of at least one predetermined read-out parameter before detection of a local deviation, and to restore said value as an initial setting when the end of said local deviation is detected.

8. A reading apparatus according to claim 1, wherein said control means (290) is adapted to control said radiation power so as to minimize said parameter.

9. A reading apparatus according to claim 1 adapted to read out a first storage layer (S1) independently of a second storage layer (S2).

10. A reading apparatus according to claim 9, further comprising setting means (290) for setting said radiation power to a first value for reading from said first storage layer and to a second value for reading from said second storage layer;

11. A reading apparatus according to claim 10, wherein said first value of said radiation power is determined by a compensation temperature of said second storage layer (S2) and said second value of said radiation power is determined by a compensation temperature of said first storage layer (S1).

12. A method of reading a magneto-optical recording medium (10) comprising at least one storage layer (S1, S2) and a read-out layer (RO), wherein an expanded domain leading to a read-out pulse is generated in said read-out layer (RO) by copying of a mark region from said at least one storage layer to said read-out layer through heating by a radiation power and with the help of an external magnetic field, said method comprising
a determination step for determining a parameter indicating the presence or strength of a local deviation in a read-out characteristic of said recording medium (10), and
a controlling step for controlling said radiation power on the basis of on said determined parameter.

13. A method according to claim 12, wherein said controlling step is performed independently of a copy window controlling step.

14. A method according to claim 13, wherein said copy window controlling step is a field-based or a power-based controlling step.

15. A method according to claim 12, wherein said parameter is continuously derived during read-out of said recording medium (10) from at least said recording medium (10), an error rate of a read-out signal obtained from said read-out operation, and a phase error obtained from a copy window control circuit during said read-out operation.
